(19) United States
(12) Patent Application Publication
(10) Pub. No.: US 2024/0051413 A1
(43) Pub. Date: Feb. 15, 2024

(54) CHARGING SYSTEM, VOLTAGE CONVERTER UNIT, AND ACCUMULATOR UNIT

(71) Applicants: BRUSA HyPower AG, Buchs (CH); Mercedes-Benz Group AG., Stuttgart (DE)

(72) Inventors: Hannes Hobi, Walenstadt (CH); Marc Hanselmann, Frümsen (CH)

(21) Appl. No.: 18/255,452

(22) PCT Filed: Dec. 3, 2021
(86) PCT No.: PCT/IB2021/000767

§ 371 Date: Oct. 26, 2023

(30) Foreign Application Priority Data
Dec. 4, 2020 (CH) 01541/20
Jan. 28, 2021 (CH) 00079/21

(51) Int. Cl. B60L 53/22; H02J 7/00; B60L 53/16

(52) U.S. Cl. CPC B60L 53/22; H02J 7/0045; B60L 53/16; H02J 2207/20

(57) ABSTRACT

A charging system for an electrical vehicle, the charging system including: a storage unit designed for the supply of electrical energy via two supply terminals, wherein the storage unit includes a store including two terminals disconnectably connected to the two supply terminals via a second disconnection switch and a third disconnection switch; a voltage converter unit designed as a construction unit which is separate from the storage unit and which is connected to the storage unit via three terminals, wherein in a connected state, within the storage unit, two of the three terminals are connected to the two terminals of the store, and a third of the three terminals is connected to one of the two supply terminals, and within the voltage converter unit the third of the three terminals of the voltage converter unit leads via a first disconnection switch.

### CROSS-REFERENCE TO RELATED APPLICATIONS

The present application is the U.S. National Phase of PCT/IB2021/000767, filed on Dec. 3, 2021, which claims priority to Swiss Patent Application No. 01541/20, filed on Dec. 4, 2020, and Swiss Patent Application No. 00079/21, filed on Jan. 28, 2021, the entire contents of which are incorporated herein by reference.

### BACKGROUND

### Field

The invention relates to the field of charging systems for electrical energy stores, in particular mobile electrical energy stores, in particular for electric vehicles.

### Related Art

Known charging devices, in particular, for electric vehicles, are typically connected between a charging station and an electrical energy store. They serve for adapting, on demand, a voltage which is present at the charging station to a voltage level of the energy store. This depends on the voltage at the charging station: either this voltage which is present at an input of the charging device can be switched through to the energy store (bypass mode) without a voltage conversion being necessary, or it must be converted by a converter in accordance with the voltage level of the energy store. Such charging devices can be subjected to regulations, according to which the energy store must be able to be disconnected in a full-pole manner from the charging station by way of mechanical disconnection switches.

In known charging devices, a voltage converter unit is present, wherein the voltage converter unit is connected between the charging station and the energy store—typically a rechargeable battery or accumulator. In bypass operation, rapid charging procedures can be carried out, during which relatively high currents occur, so that conductor cross sections in the voltage converter unit need to be designed accordingly large. Furthermore, for the full-pole disconnection, several disconnection switches need to be present in the voltage converter unit. Moreover, with regard to a modular construction selectively with or without a voltage converter unit, an unnecessary doubling of the elements can occur.

Examples of a known charging device are disclosed in DE 10 2017 220 287 A1 and DE 10 2018 207 185.

### Summary

It is therefore the object of the invention to provide a charging system, a voltage converter unit, and a storage unit, of the initially mentioned type, which overcome the aforementioned disadvantages.

At least one of these objects is achieved by a charging system, a voltage converter unit, and a storage unit with the features of the respective independent claims.

Herewith, it is possible, by way of the three disconnection switches, to disconnect the store as well as a voltage converter which is arranged in the voltage converter unit, from the supply terminals in a full-pole manner.

Furthermore, it is possible to equip the voltage converter unit with only a single disconnection switch or even with no disconnection switch, since further disconnection switches are present in the storage unit and—since the voltage converter unit is not directly connected to the charging station, but via the storage unit—it is possible for the disconnection of the voltage converter unit from the charging station to be able to be effected via the disconnection switches in the storage unit.

It is further possible to connect the storage unit directly onto the charging station via the two supply terminals, without the conductors which are used for this being led through the voltage converter unit. By way of this, in turn high currents as occur given a rapid charging in bypass mode do not need to be led through the voltage converter unit, and conductors in the voltage converter unit can be designed accordingly smaller.

It is further possible to design and operate the storage unit completely without the voltage converter unit. Herein, the two supply terminals of the storage unit can be adopted and operated in an unchanged manner, just as supply lines for connection to a charging station. Thus, starting from the same storage unit, one can realise a configuration with or without the voltage converter unit. In manufacture, this is advantageous due to the storage unit being able to be applied for both configurations in an unchanged manner. Moreover, a storage unit or a vehicle which contains this can also be retrofitted with a voltage converter unit after starting operation. The voltage converter unit can be present as a module, or not. Such a module includes only a single disconnection switch or even no disconnection switch. A total number of disconnection switches is hereby minimised.

In various embodiments, the charging system is designed according to claim 2.

In various embodiments, the charging system is designed according to claim 3. Herewith, it is possible to manufacture the charging system in the form of separate modules, i.e., voltage converter unit and storage unit, and to bring them together for use. In particular, the charging system which is modularised in such a manner can be operated selectively with or without the voltage converter unit.

In various embodiments, the charging system is designed according to claim 4, Herewith, it is possible to create and release the connection between the voltage converter unit and the storage unit in a simple manner.

In various embodiments, the storage system is designed according to claim 5. Herewith, it is possible to operate the storage system with a locking system as is common in electrical vehicle technology, for example, Interlock or HV-Interlock, or with pilot contacts.

In various embodiments the charging system is designed according to claim 6 and/or claim 7. Herewith, the charging system is suitable for use in an electrical vehicle. Suitable voltages of the charging system can be for example 400 volts or 800 volts.

The various voltage converter unit is designed according to claim 8. Herewith, the input terminal can be disconnected from the voltage converter of the voltage converter unit by way of the first disconnection switch.

The storage unit is designed according to claim 9. Herewith, the storage unit can be selectively operated with or without a voltage converter unit.

### BRIEF DESCRIPTION OF THE DRAWINGS

The subject matter of the invention is hereinafter explained in more detail by way of preferred embodiment examples which are represented in the accompanying drawings. In each case shown schematically are:

FIG. 1 showing a charging system with a voltage converter unit and a storage unit;

FIG. 2 showing the charging system with a specific first embodiment of the voltage converter unit;

FIG. 3 showing a charging system with a voltage converter unit and a storage unit, according to a second embodiment; and

FIG. 4 showing the charging system according to the second embodiment with a specific second embodiment of the voltage converter unit.

Basically, in the figures the same or functionally equivalent parts are provided with the same reference numerals.

### DETAILED DESCRIPTION

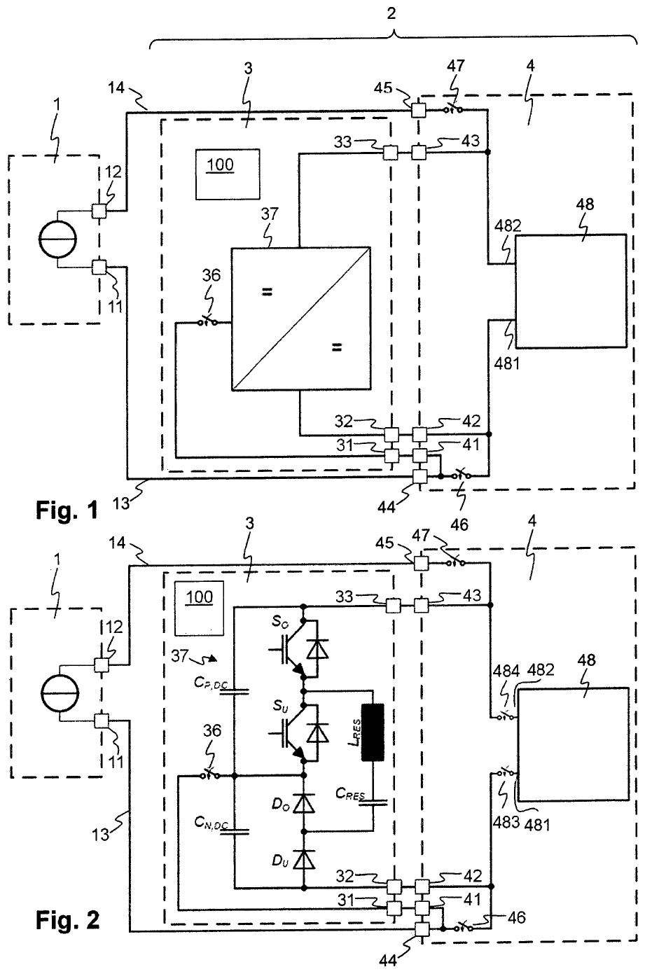

FIG. 1 shows a charging system 2, connected to a charging station 1. The charging system 2 includes a voltage converter unit 3 and a storage unit 4.

The voltage converter unit 3 includes an input terminal 31, an output terminal 32, a common terminal 33 and a voltage converter 37 for converting an input voltage which is present between the input terminal 31 and the common terminal 33 into an output voltage which is present between the output terminal 32 and the common terminal 33.

During operation of the voltage converter 37, its input voltage is equal to an output voltage of the charging station 1, and its output voltage is equal to a voltage of the store 48.

The storage unit 4 includes
a first terminal 41 for the connection to the input terminal 31 of the voltage converter unit 3,
a second terminal 42 for the connection to the output terminal 32 of the voltage converter unit 3 and for feeding a first terminal 481 of the store 48,
a third terminal 43 for the connection to the common terminal 33 of the voltage converter unit 3 and for feeding a second terminal 482 of the store 48,
a first supply terminal 44 for the connection to a first charging terminal 11 of a charging station 1, and
a second supply terminal 45 for the connection to a second charging terminal 12 of the charging station 1.

The connection of the first supply terminal 44 and second supply terminal 45 to a first charging terminal 11 and a second charging terminal 12 respectively of the charging station 1 is effected via a first supply line 13 and a second supply line 14 respectively.

In various embodiments, the two supply lines 13, 14 are designed as separate cables and the two supply terminals 44, 45 are formed on separate plugs. Herewith, one succeeds in the individual, separate cables not becoming too heavy, in the case they need to be designed for high charging currents.

In various embodiments, the two supply lines 13, 14 are designed in a common cable and the two supply terminals 44, 45 are formed on a common plug.

Within the voltage converter unit 3
the input terminal 31 of the voltage converter unit 3 is disconnectable from the voltage converter 37 via a first disconnection switch 36.

Within the storage unit 4
the first supply terminal 44 is connected to the first terminal 41 of the storage unit 4,
the second terminal 42 of the storage unit 4 and the first terminal 481 of the store 48 are disconnectably connected to the first supply terminal 44 via a second disconnection switch 46, and
the third terminal 43 of the storage unit 4 and the second terminal 482 of the store 48 are disconnectably connected to the second supply terminal 45 via a third disconnection switch 47.

In various embodiments, instead of the first supply terminal 44, it is the second supply terminal 45 which is connected to the first terminal 41 of the storage unit 4. Given the same polarity of the store 48 and of the charging station 1, this corresponds to an operating manner of the voltage converter 37 with a reversed polarity.

The storage unit 4 and, in particular, the store 48 can be equipped with a battery management system (not shown) and/or a closed-loop control of the charging of a known type. The latter can control, for example, the charging station 1 and/or the voltage converter unit 3 via communication connections (not shown).

In various embodiments, the storage unit 4 is part of a consumer circuit, in the case of a vehicle also known as a traction circuit, or is connected to a consumer circuit. Furthermore, the storage unit 4 can include further disconnection switches 483, 484 for disconnecting the first and second terminals 481, 482 of the store 48 from the remaining elements, for example, from the voltage converter unit 3 and the consumer circuit. The presence of such further disconnection switches 483, 484 for the disconnection of the storage unit 4 can be prescribed by standards.

The control of the disconnection switches 36, 46, 47 and of the voltage converter 37 is effected by a controller 100 and communication connections (not shown). By way of example, the controller 100 is arranged in the voltage converter unit 3 but can also be arranged in the storage unit 4 or outside both units. Further common elements for ensuring the functioning and safety, for example, for monitoring the supply terminals 44, 45 are not shown.

In the case that the voltage which is provided by the charging station 1 is not equal to that voltage which is required for charging the store 48, the charging system 2 can be switched into a converter mode. In the converter mode, the second disconnection switch 46 is opened and the first disconnection switch 36 and third disconnection switch 47 are closed. The voltage converter 37 is pulsed.

Herein, the voltage converter 37 converts the voltage of the first charging terminal 11 which is present at the input terminal 31 of the voltage converter unit 3 via the first terminal 41 and the first supply terminal 44 of the storage unit 4 and first supply line 13 into the voltage which is present at the output terminal 32 of the voltage converter unit 3. This voltage is present at the first terminal 481 of the store 48 via the second terminal 42 of the storage unit 4. The mentioned voltages are with respect to the common terminal 33.

The voltage of the second charging terminal 12 is present at the third terminal 43 of the storage unit 4 via the second supply line 14 and the second supply terminal 45 and thus at the common terminal 33 of the voltage converter unit 3 as well as at the second terminal 482 of the store 48.

In the case that the voltage which is provided by the charging station 1 is equal to the voltage which is required for charging the store 48, the charging system 2 can be switched into a bypass mode. In the bypass mode, the first disconnection switch 36 is opened and the second disconnection switch 46 and third disconnection switch 47 are closed. The voltage converter 37 is not clocked. The voltage of the charging station 1 is present at the store 48.

In the case that the charging system 2 is to be galvanically separated from the charging station, all three disconnection switches 36, 46, 47 are opened.

The store 48 is typically a rechargeable battery or accumulator.

As a rule, the voltage converter 37 is a DC-DC converter. For example, it can be a charging pump, a boost converter, a buck-converter, or a combination as a boost-buck converter, or have a different topology, for example, a bridge circuit which realises a DC-DC converter. A charge pump can be designed for doubling the voltage or for voltage multiplication.

As a rule, in operation the voltage converter 37 transfers electrical energy from the charging station 1 which feeds the voltage converter 37 via the input terminal 31 and the common terminal 33, to the store 48 which is fed from the voltage converter 37 via the output terminal 32 and the common terminal 33. In various embodiments, a re-feed mode can also be additionally realised, in which energy is transferred in the opposite direction. For the re-feed mode, passive valves (diodes) can be replaced by active semiconductor switches in the voltage converter 37.

FIG. 2 shows a charging system 2 in which the voltage converter 37 is designed as a charge pump. In the embodiment of the charge pump which is shown here, an inductance L_{RES} is in series with a store capacitance C_{RES}, by which means a resonant oscillation circuit is formed. The manner of functioning of this voltage converter 37 is explained in WO 2018/046370 A1, whose content is expressly incorporated herein in its entirety by reference. FIG. 2 also shows the further disconnection switches 483, 484 for separating the store 48. These disconnection switches 483, 484 can also be present in the general representation according to FIG. 1.

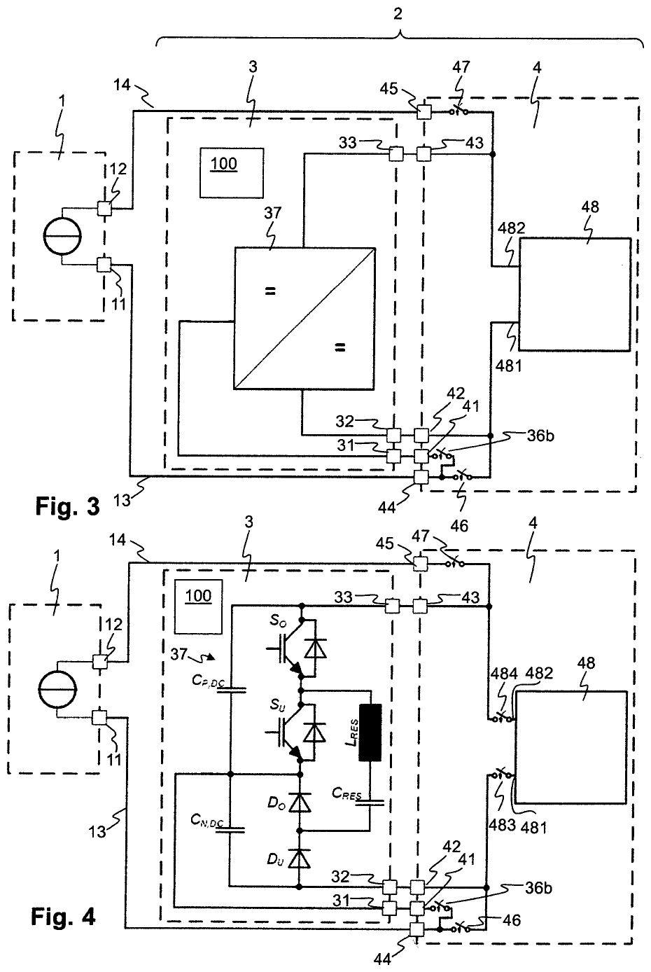

FIGS. 3 and 4, analogously to the FIGS. 1 and 2 each show a charging system, in which the first disconnection switch 36 is not arranged in the voltage converter unit 3 but as a first disconnection switch 36 in the storage unit 4. Herein, the first supply terminal 44 or the second supply terminal 45 of the storage unit 4 is disconnectably connected to the first terminal 41 of the storage unit 4 via the first disconnection switch 36b of the storage unit 4. Thus in the embodiments of FIGS. 3 and 4, no disconnection switch is present in the voltage converter unit 3, in particular, no disconnection switch for disconnecting the three terminals 31 of the voltage converter unit 3.

1. A charging system for an electrical vehicle, the charging system comprising:
a storage unit designed for supply of electrical energy via two supply terminals, wherein the storage unit comprises a store comprising two terminals disconnectably connected to the two supply terminals via a second disconnection switch and a third disconnection switch; and
a voltage converter unit designed as a construction unit which is separate from the storage unit and which is connected to the storage unit via three terminals of the voltage converter unit, wherein in a connected state:
within the storage unit
two of the three terminals of the voltage converter unit are connected to the two terminals of the store, and
either according to a second embodiment variant within the storage unit
the third of the three terminals of the voltage converter unit is connected to one of the supply terminals via a first disconnection switch,
or according to a first embodiment variant
within the storage unit
the third of the three terminals of the voltage converter unit is connected to one of the two supply terminals; and
within the voltage converter unit the third of the three terminals of the voltage converter unit leads via a first disconnection switch.

2. The charging system according to claim 1,
wherein the voltage converter unit comprises:
an input terminal,
an output terminal,
a common terminal, and
a voltage converter for converting an input voltage which is present between the input terminal and the common terminal into an output voltage which is present between the output terminal and the common terminal;
wherein the storage unit comprises:
a first terminal for the connection to an input terminal of the voltage converter unit,
a second terminal for the connection to the output terminal of the voltage converter unit and for feeding a first terminal of the store,
a third terminal for the connection to the common terminal of the voltage converter unit and for feeding a second terminal of the store,
a first supply terminal for the connection to a first charging terminal of a charging station, and
a second supply terminal for the connection to a second charging terminal of the charging station, and
wherein:
either according to the second embodiment variant
within the storage unit
the first supply terminal is disconnectably connected to the first terminal of the storage unit via the first disconnection switch,
the second terminal of the storage unit and the first terminal of the store are disconnectably connected to the first supply terminal via the second disconnection switch, and
the third terminal of the storage unit and the second terminal of the store are disconnectably connected to the second supply terminal via the third disconnection switch,
or according to the first embodiment variant
within the voltage converter unit
the input terminal of the voltage converter unit is disconnectable from the voltage converter via the first disconnection switch,
within the storage unit
the first supply terminal is connected to the first terminal of the storage unit,
the second terminal of the storage unit and the first terminal of the store are disconnectably connected to the first supply terminal via the second disconnection switch, and
the third terminal of the storage unit and the second terminal of the store are disconnectably connected to the second supply terminal via the third disconnection switch.

3. The charging system according to claim 1, wherein the voltage converter unit is designed to be able to be manufactured, handled, and transported independently of the storage unit.

4. The charging system according to claim 1, wherein the three terminals via which the voltage converter unit is connected to the storage unit are releasable and reconnectable terminals.

5. The charging system according to claim 1, wherein the supply terminals are formed on a single plug or on two separate plugs.

6. The charging system according to claim 1, wherein the supply terminals are designed for a maximal rapid charging current which is more than double a maximal charging current capable of being provided by the voltage converter unit.

7. The charging system according to claim 1, wherein the supply terminals are designed for a maximal rapid charging current of above 300 amperes and/or the voltage converter unit is designed for a maximum charging current of above 50 amperes.

8. A voltage converter unit comprising:
an input terminal for the connection to a first pole of an input voltage source;
an output terminal for the connection to a first pole of a consumer which is to be fed; and
a common terminal for the connection to a second pole of the input voltage source and to a second pole of the consumer,
wherein the input terminal leads via a first disconnection switch.

9. A storage unit comprising:
two supply terminals;
a store comprising two terminals which are disconnectably connected to the two supply terminals via a second disconnection switch and a third disconnection switch; and
three terminals for connection to corresponding terminals of a voltage converter unit, wherein
within the storage unit
two of the three terminals are connected to the two terminals of the store, and
either according to a second embodiment variant
a third of the three terminals is disconnectably connected to one of the two supply terminals via a first disconnection switch,
or according to a first embodiment variant
the third of the three terminals is connected to one of the two supply terminals.

10. The charging system according to claim 4, wherein the releasable and reconnectable terminals are plug-in terminals, screw terminals, or clamping terminals.

11. The charging system according to claim 5, wherein the single plug or the two separate plugs each have safety contacts for a pilot circuit or a safety circuit respectively.

12. The charging system according to claim 7, wherein the supply terminals are designed for a maximal rapid charging current of above 400 amperes, and/or the voltage converter unit is designed for a maximum charging current of above 100 amperes.
